(19) United States
(12) Patent Application Publication
(10) Pub. No.: US 2005/0164771 A1
(43) Pub. Date: Jul. 28, 2005

(54) Method, apparatus, and program product for producing intermediate results in bingo games

(76) Inventors: Clifton Lind, Austin, TX (US); Jefferson C. Lind, Austin, TX (US)

Correspondence Address: THE CULBERTSON GROUP, P.C., 1114 LOST CREEK BLVD., SUITE 420, AUSTIN, TX, 78746, US

(21) Appl. No.: 10/869,159

(22) Filed: Jun. 16, 2004

Related U.S. Application Data
(60) Provisional application No. 60/538,196, filed on Jan. 22, 2004.

(51) Int. Cl. G06F 17/00; G06F 19/00

(52) U.S. Cl. 463/19

(57) ABSTRACT

A gaming method identifies a variable draw dividing point in a designation set or draw. This variable draw dividing point divides the draw into two subsets of designations including a first draw portion. The first draw portion defined by the variable draw dividing point in the draw matches card representations in play in a bingo game according to some predefined matching criteria. Once the variable draw dividing point is identified to define the first draw portion, the first draw portion is communicated to players in the bingo game that are each associated with a respective card representation matched by the first portion according to the predefined matching criteria.

### CROSS-REFERENCE TO RELATED APPLICATION

The Applicants claim the benefit, under 35 U.S.C. 119(e), of U.S. Provisional Patent Application 60/538,196 filed Jan. 22, 2004 and entitled METHOD, APPARATUS, AND PROGRAM PRODUCT FOR PRODUCING INTERMEDIATE RESULTS IN BINGO GAMES. The entire content of this provisional application is incorporated herein by this reference.

### TECHNICAL FIELD OF THE INVENTION

This invention relates to gaming and gaming systems. More particularly, the invention relates to a bingo gaming system that facilitates increased player interaction over the course of a bingo game.

### BACKGROUND OF THE INVENTION

The game known as “bingo” is played with predefined bingo cards that each include a number of bingo designations such as Arabic numerals randomly arranged in a desired manner, commonly in a grid. The bingo designations on the cards are selected from a pool of available designations. In traditional bingo games the cards are physically printed on paper or other suitable material. These traditional printed cards are purchased by players prior to the start of a game. After a buy in period in which players purchase bingo cards for a game, designations from the available pool of designations are selected at random. As the designations are selected and announced in the game, the players match the randomly selected designations with the designations printed on their respective card or cards. This matching and marking of matched designations on the bingo card is commonly referred to as “daubing” the card. The player first producing a predetermined pattern of matches between the randomly selected designations and the printed card designations on a single card, and then announcing “bingo” to claim the win, is considered the winner. Consolation prizes may be awarded to players having cards matched to produce consolation prize patterns at the time of the winning pattern. Additional prizes may be awarded during the course of a traditional bingo game to players matching other patterns prior to the time the game ending or winning pattern is first produced.

There are numerous variations on the traditional bingo game. One particular variation on the traditional bingo game is played with electronic bingo card representations rather than the traditional printed bingo cards. In these electronic bingo games, each bingo card is represented by a data structure that defines the various card locations and designations associated with the locations. The game is played through player stations connected via a communications network. A central computer system or game server in the network may be responsible for storing the bingo card representations and distributing or communicating bingo card representations to players at the player stations. The player stations display the bingo cards defined by the card representations and also allow the players to daub or mark designation matches as game designations are announced in the game. A primary advantage of this type of electronic bingo game is that the games may be played at a much faster pace than is practical with traditional paper bingo. Another advantage of this electronic version of bingo is that the games can be administered and controlled from a remote location and actually played at a number of different bingo establishments, thus allowing greater participation in the games.

Despite the improvement in the speed of play available in electronic implementations of bingo games, the individual games may still be played relatively slowly. The time required for players to buy in to the bingo game with one or more bingo cards, for producing a ball draw or other designation sequence, and for players to daub their card or cards and then claim their results may take a significant period of time depending upon the particular implementation and game rules. The long period between the start of the game and the identification of the game winner or winners in the bingo game generally reduces player enjoyment, and may make bingo unattractive in comparison to other games that may be available in a jurisdiction or competing jurisdiction.

### SUMMARY OF THE INVENTION

The present invention breaks up the set of designations drawn or otherwise generated for the play of a bingo game into subsets or portions of variable size in order to achieve some goal in the gaming system. In particular, a designation set may be divided into two or more portions which may be revealed to the players separately. The goal of dividing the designation set may be to ensure that the game ending pattern in not produced on any card in a bingo game after only the first subset or portion of the draw is revealed. Another goal that may be achieved in the present invention by dividing the set of game designations into variable subsets or portions is to help occupy players other than the apparent game ending winner in the bingo game while the apparent game ending winner takes the time to daub and claim their game ending win.

A gaming method according to the invention includes the step of identifying a variable draw dividing point in a designation set or draw. This variable draw dividing point divides the draw into two subsets of designations. The first subset of designations comprises the first, second, third, etc. designation in the draw up to a number of designations indicated by the draw dividing point. This first subset of the draw may be referred to as a first draw portion.

According to the invention, the first draw portion defined by the variable draw dividing point in the draw matches at least a first card representation in play in a bingo game according to some predefined matching criteria. The predefined matching criteria may require, for example, that the first card representation in the set or each card representation in the set does not match the first draw portion to produce a game ending pattern or result in the bingo game. The predefined matching criteria may alternatively or in addition require that one or more card representations in the set match the first draw portion to produce some intermediate winning pattern or result.

Dividing the draw into different subsets according to some predefined matching criteria with the card representations in play in a bingo game allows a draw in the bingo game to be communicated to one or more of the bingo players in two distinct actions. Communicating the draw in this fashion may help facilitate the rules of the bingo game. For example, bingo game rules may require that each player take a certain action in the bingo game before the game ends. Variably dividing the draw according to the invention allows the game to be designed so that each player receives a portion of the draw, and then must take some action before receiving the remainder of the draw required to produce a game ending pattern on one of the card representations in play in the game. Communicating in multiple sets of designations may also help ensure one or more players in the game achieve some interim or intermediate prize to provide entertainment while the result in the underlying bingo game is identified and awarded. For example, the number of designations communicated to a player may be varied so that some intermediate winning pattern is revealed after the first draw portion so that the player is entertained while the apparent game ending winning player takes the actions required to claim the game ending win.

The method of the invention is preferably performed by processing devices under the control of operational program code. For example, a gaming system according to the invention may include a number of player stations or player interface devices all connected for communication with a game server processing device. The game server would preferably comprise a suitable processing device executing identifying program code for identifying the variable draw dividing point according to the predefined matching criteria for matching between the first draw portion and the at least on card representation. Result communication program code would be executed to cause the first draw portion to be communicated to the appropriate player stations. This result communication program code might also be responsible for causing the remaining portion or portions of the draw to be communicated the appropriate player stations in response to some action or signal at the stations.

### BRIEF DESCRIPTION OF THE DRAWINGS

FIG. 1 is a high level diagrammatic representation of a bingo gaming system in which the present invention may be implemented.

FIG. 2 is a diagrammatic representation of a computer system arrangement that may be used for the central game server and local area servers included in the system shown in FIG. 1.

FIG. 3 is a diagrammatic representation of an electronic player station that may be used in the system shown in FIG. 1.

FIG. 4 is a diagrammatic representation showing process steps embodying the principles of the invention.

FIG. 5 is a diagrammatic representation illustrating one method of identifying a variable draw dividing point within the scope of the present invention.

FIG. 6 is a diagrammatic representation illustrating another method of identifying a variable draw dividing point within the scope of the present invention.

### DESCRIPTION OF PREFERRED EMBODIMENTS

The claims at the end of this application set out novel features which the Applicants believe are characteristic of the invention. The various advantages and features of the invention together with preferred modes of use of the invention will best be understood by reference to the following description of illustrative embodiments read in conjunction with the drawings introduced above.

The present invention may be used to divide the draw in many different types of bingo gaming systems. The following description of the present invention will be made in reference to a particular bingo gaming system disclosed fully in U.S. patent application Ser. No. 10/456,721 entitled “Method, System, and Program Product for Conducting Multiple Concurrent Bingo-Type Games,” the entire content of which is incorporated herein by this reference. However, it should be noted that the invention is not limited to any particular bingo gaming system. Rather, the invention may be used in connection with any bingo gaming system.

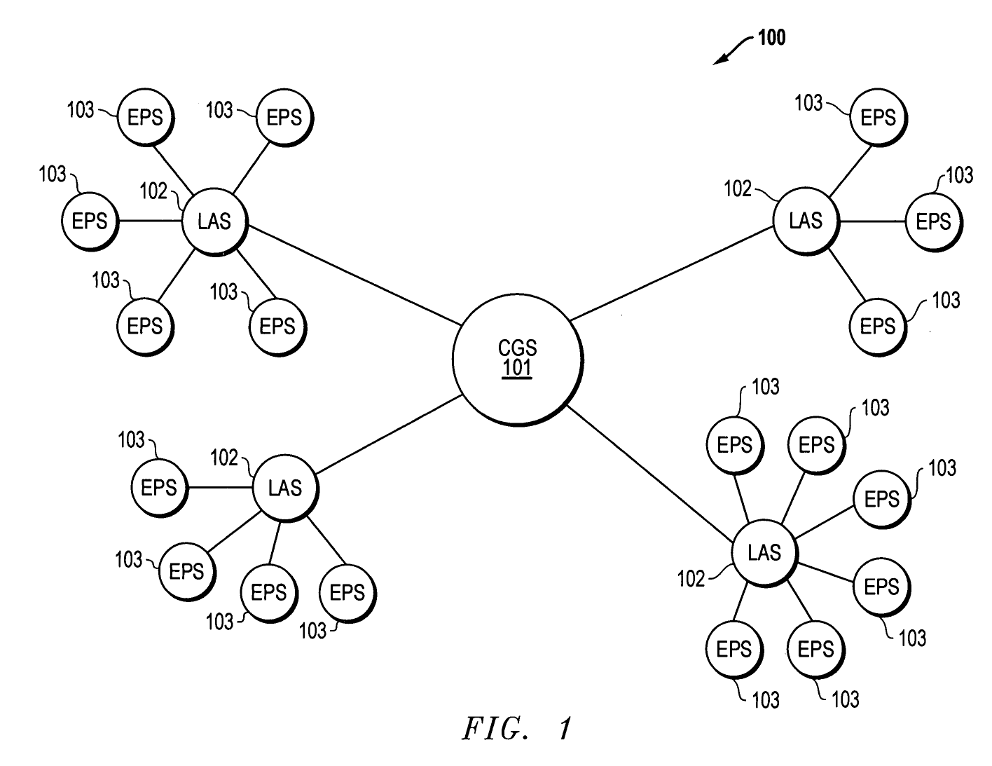

FIG. 1 shows a gaming system 100 including a central game server (CGS) 101 that cooperates with a number of other components to enable bingo players, preferably at many different remote gaming sites, to participate in bingo games. Each gaming site includes a local area server (LAS) 102 and a number of electronic player stations (EPSs) 103. As will be discussed in detail below, in the normal operation of gaming system 100, a player at any EPS 103 in the system may participate in a given bingo game with players at any other EPSs 103 in the system. Thus, players at different gaming facilities may be grouped together for a given bingo game administered through system 100. Grouping together players from different gaming facilities for the play of a bingo game allows different bingo games to be played rapidly and minimizes the time that players must wait to receive the result of their participation in the bingo game.

The system includes an arrangement for grouping players and/or game play requests for the play of a single bingo game to facilitate rapid play. This grouping includes limiting the number of players and/or game play requests included in a bingo game to reduce the time required to play the game. System 100 reduces the time between a game play request at one of the EPSs 103 and the return of results to the respective EPS sufficiently to allow a great deal of flexibility in how results in the bingo game are displayed to the player. In particular, the bingo game results may be displayed in some manner unrelated to bingo. For example, the bingo game results may be mapped to a display traditionally associated with a reel-type game (slot machine), to a display relating to a card game, or to a display showing a race such as a horse or dog race, for example. Preferred techniques for mapping bingo game results to displays associated with games or contests unrelated to bingo are described in U.S. patent application Ser. No. 10/060,643 filed Jan. 30, 2002, and entitled “Method, Apparatus, and Program Product for Presenting Results in a Bingo-Type Game.” The entire content of this prior application is incorporated herein by this reference.

System 100 rapidly groups players and/or game play requests and starts one game after another so that multiple games may be in play at any given time. That is, once a first group of players or game play requests has been assigned to a bingo game offered through system 100, the system proceeds to simultaneously administer a bingo game for the first group of players or game play requests and also begin grouping players or game play requests for a next bingo game. System 100 does not necessarily wait for one bingo game to be completed before starting to collect players or game play requests for, and actually beginning play in, the next bingo game. The number of players or game play requests grouped for the play of bingo games according to the present invention may be limited to reduce the time required for grouping. For example, each bingo game offered through gaming system 100 shown in FIG. 1 may be limited to between 2 to 20 players or game play requests, with the preferred number for any given game being from 10 to 15. Where system 100 includes numerous EPSs 103 at the various remote locations, on the order of several thousand EPSs for example, hundreds of individual bingo games may be in process at any given time through the gaming system.

Regardless of the rapid play facilitated by system 100 and regardless of the manner in which the bingo game results are displayed, the underlying game remains a standard bingo game played in the traditional sequence of play for bingo games. That is, each player obtains or is assigned a bingo card or bingo card representation, all bingo cards in play in the game are daubed or checked for matches with a draw, and the first card in the game to match the sequence of designations to produce the game ending winning pattern represents the card that may win the bingo game, subject to any required claiming action required under the rules of the game. Additional prizes may be awarded for other patterns that may be produced in the course of the bingo game. The mapping of different prizes to various bingo patterns that may be produced in the course of a bingo game in system 100 may be accomplished as described in U.S. Pat. No. 6,569,017 B2, entitled “Method for Assigning Prizes in Bingo-Type Games” or U.S. patent application Ser. No. 10/238,313, filed Sep. 10, 2002, entitled “Prize Assignment Method and Program Product for Bingo-Type Games.” The entire content of each of these documents is incorporated herein by this reference.

As used in this disclosure any sequence of designations that may be matched against bingo cards or card representations in the course of a bingo game is referred to as a “draw” regardless of how the sequence is actually generated. Under this definition, it will be appreciated that a draw may be produced by a random number generator, a pseudo random number generator, or any other suitable device or system, such as a manual, semi-automatic, or fully automatic physical ball draw device.

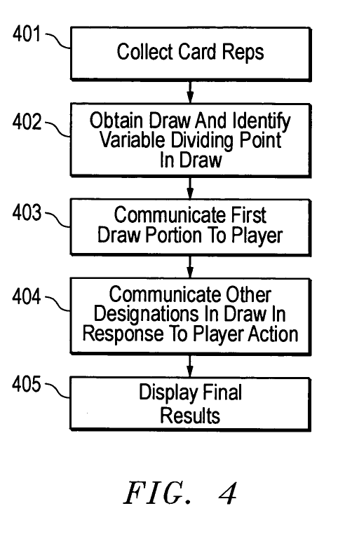

CGS 101 may comprise a computer system such as the basic system shown in FIG. 2. The basic system may include one or more processors 200, nonvolatile memory 201, volatile memory 202, a user interface arrangement 203, and a communications interface 204, all connected to a system bus 205. It will be appreciated that user interface arrangement 203 may include a number of different devices such as a keyboard, a display, and a pointing device such as a mouse or trackball for example, although not shown in FIG. 2. Alternatively to the integrated user interface arrangement 203 shown in FIG. 2, a user interface for CGS 101 may be provided through a separate computer (not shown) in communication with the CGS. Regardless of the particular configuration for CGS 101, in the normal operation of system 100 shown in FIG. 1, the CGS functions to group players for participation in bingo games offered through the system, produces or obtains sequences of designations (ball draws, for example) for the play of the bingo games, checks for the results in the bingo games, and communicates the results to the EPSs 103 through LASs 102. Specific processes that may be performed by CGS 101 to produce the variable draw dividing point according to the invention will be described below with reference to FIG. 4.

Each LAS 102 included in system 100 as shown in FIG. 1 may comprise a computer system having the same basic structure as shown in FIG. 2. That is, each LAS 102 may include one or more processors 200, nonvolatile memory 201, volatile memory 202, user interface arrangement 203, and communications interface 204 all connected to system bus 205. As with CGS 101, the user interface for the respective LAS 102 may be provided through a separate computer and communications with the LAS rather than the integrated user interface arrangement 203 shown in FIG. 2. Regardless of the specific configuration of the LAS, each LAS serves, in normal operation of the system shown in FIG. 1, to transfer or relay information from its respective EPSs 103 to CGS 101 and transfer or relay information from the CGS to the LAS's respective EPSs. Each LAS according to the present invention may also have the ability to group players and actually play bingo games in certain situations. For example, where one LAS 102 serves a large number of EPSs 103, the LAS may group players or game play requests from its respective EPSs during a time of high player activity, obtain or produce a ball draw, determine results, and return results to the EPSs rather than having the CGS 101 perform these tasks. Also, each LAS 102 shown in FIG. 1 may be configured to perform the tasks normally performed by CGS 101 in the event the communications link between the respective LAS and CGS is degraded below a certain level or is severed altogether. Thus, the processes of the game server described below with reference to FIG. 4 may be performed at a LAS 102 within the scope of the present invention.

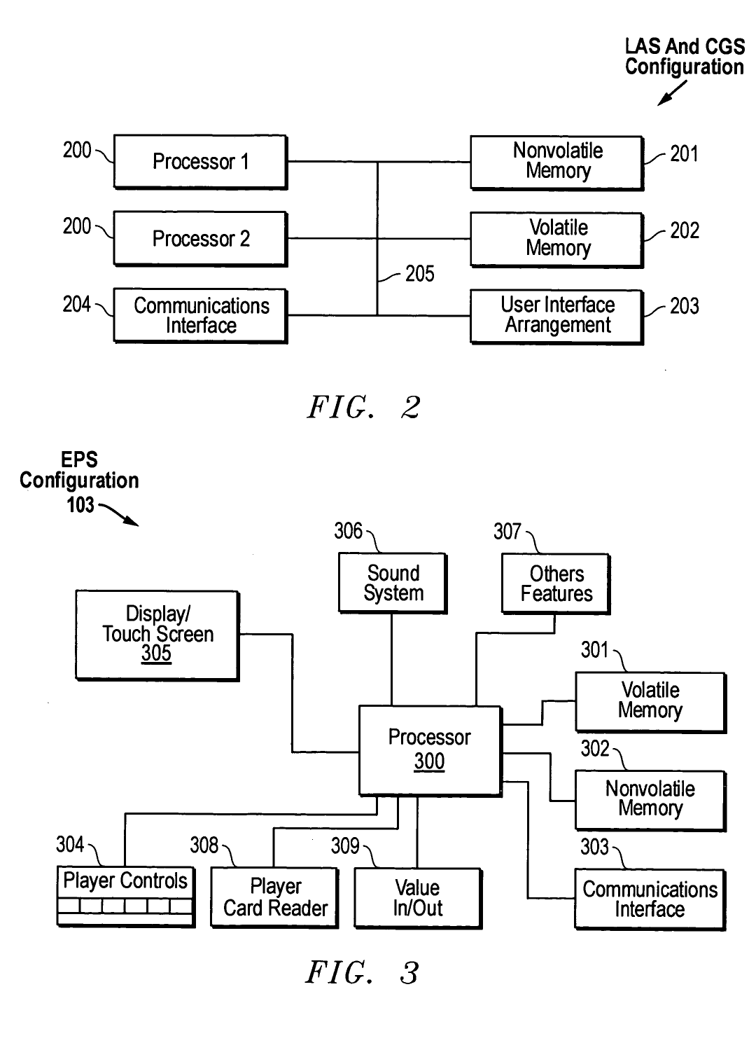

FIG. 3 shows an example of an EPS 103 that may be used as a player interface device in a gaming system that may employ variable draw divisions according to the present invention. The illustrated EPS 103 includes a processor 300, volatile memory 301, nonvolatile memory 302, and a communications interface 303. The volatile and nonvolatile memory stores computer program code that may be executed by processor 300 to cause the processor to perform or direct the various functions provided by EPS 103. Communications interface 303 allows communications between EPS 103 and its respective LAS 102 and/or CGS 101. EPS 103 also includes a special user interface arrangement to facilitate player participation in the bingo games offered through gaming system 100 shown in FIG. 1, and display results in an exciting and attractive format. This interface includes player controls 304, a display or touch screen display 305, a sound system 306, and perhaps other features 307 such as alarms or special displays or alerting devices. Each EPS 103 also preferably includes a convenient system for allowing the player to input player-specific information and for receiving wagers and dispensing winnings. For example, the EPS 103 shown in FIG. 3 includes a player card reader 308 that is adapted to read player-specific information from a player account card inserted into the reader. A player account card may, for example, include player information or simply a player identifier encoded on a magnetic medium (mag stripe) associated with the card, or encoded on bar code, or a memory device associated with the player card. The illustrated EPS 103 also includes a device 309 for receiving value and issuing value in the course of play. This device may accept currency, vouchers, or tokens, for example, and also output currency, vouchers, or tokens. Of course a separate device may be used to receive and issue value for games played according to the present invention. Alternatively or in addition to value in/out device 309, EPSs 103 may read player account information from the player card or player information otherwise input at the EPS, and account for wagers and winnings in the manner set out in U.S. patent application Ser. No. 10/044,478, filed Jan. 10, 2002, entitled “Distributed Account Based Gaming System,” the entire content of which is incorporated herein by this reference.

It will be appreciated that the particular configuration of devices shown in FIG. 1 is shown only for purposes of example. A bingo gaming system in which the present invention may be used may omit some or all of the separate LASs 102 at the various gaming facilities so that the EPSs 103 communicate directly with CGS 101. Also, various regions or different gaming facilities may be divided up into separate systems each having a respective CGS such as CGS 101. In these situations the system could be configured such that a single EPS 103 may be serviced by any of the CGSs. Furthermore, a gaming system using variable draw divisions according to the invention may include multiple CGSs rather than a single CGS 101 as shown in FIG. 1.

Details regarding the particular functions performed by CGS 101, LASs 102, and EPSs 103 according to one preferred implementation for the present intention are described in U.S. patent application Ser. No. 10/456,721 entitled “Method, System, and Program Product for Conducting Multiple Concurrent Bingo-Type Games,” as referenced above. These details regarding the particular functions of CGS 101, LASs 102, and EPSs 103 in conducting bingo games will not be repeated here so as not to obscure the present invention in unnecessary detail. Rather, the remainder of this disclosure will focus on the present invention for producing variable draw divisions for use in conducting a bingo game.

In the following description of FIG. 4 and the other process flow charts in this disclosure, it will be appreciated that the references to the physical components are references to the diagrams in FIGS. 1, 2, and 3 that show those components. The components, such as EPSs 103, LASs 102, and CGS 101 discussed with reference to the flow charts are generally not shown in the flow charts themselves but are shown particularly in FIG. 1.

A method embodying the principles of the invention may be described with reference to FIG. 4. As shown at process block 401, the method includes collecting or obtaining card representations for the play of a bingo game. This step is preferably performed by a suitable game server such as CGS 101 shown in FIG. 1, or a LAS 102 configured to function as a game server. Again, the specific manner in which card representations are collected and grouped for the play of a bingo game is not relevant to the present invention. For the purposes of the present invention, it matters only that there is some set or group of bingo card representations in play for a particular bingo game.

The present invention also includes the step of obtaining a draw and identifying a variable draw division point in the draw as indicated at process block 402. As mentioned above, a draw may be obtained in any suitable fashion such as with a random number generator, pseudo random number generator, or other randomizing arrangement such as a physical object draw device. Depending on specifically how the draw is produced, the draw may be produced by the game server processing device itself. Alternatively, the draw may be obtained from some additional device in communication with the game server.

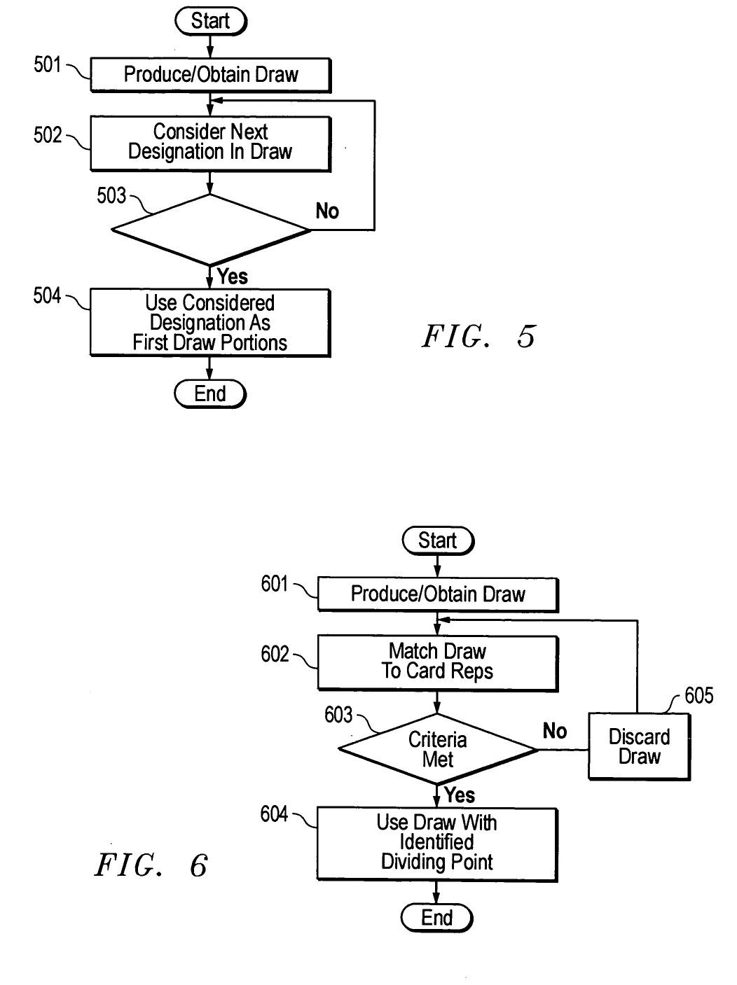

Identifying the variable draw dividing point as shown at process block 402 may be accomplished in a number of different fashions within the scope of the present invention. Specific examples of processes by which the draw dividing point may be identified are described below with reference to FIGS. 5 and 6. In any case, however, the variable draw dividing point is selected or identified such that it defines a first draw portion that matches at least one of the card representations in play for the bingo game according to some predefined matching criteria. It should be noted here that the first draw portion matches a card representation by matching the individual designations included in the first draw portion to the individual card representation to identify each individual location of the card representation that is associated with or contains a designation that is also included in the first draw portion.

The process performed to identify the variable draw dividing point within the scope of the present invention is preferably performed by identifying program code executed at the game server or other suitable processing device. The identifying program code may operate by actually matching a draw or portions of a draw to a one or more card representations in play for a bingo game. The processes shown in FIGS. 5 and 6 use designation matching to identify the variable draw dividing point. However, it will be appreciated that other processes may be used to identify the variable draw dividing point and ensure that the first draw portion defined thereby meets the predefined matching criteria. For example, data regarding projected odds for obtaining certain patterns in a certain number of designations from a draw may be used to initially identify the variable draw dividing point. The actual draw data may then be checked by matching against the particular card representations in play to verify that the predefined matching criteria are met for the first draw portion defined by the variable draw dividing point.

The predefined matching criteria may be substantially any criteria (including a single criterion) that suits the purpose of the draw division in the bingo gaming system. For example, the predefined matching criteria may require that the first draw portion cannot match any individual card in the set of card representations to produce a game ending pattern for the bingo game. Along with this requirement prohibiting game ending patterns achieved with the first draw portion, the criteria may also require that the first draw portion be as close as possible to including one-half of the total number of designations required to first produce a game ending pattern in the bingo game. This sort of criteria for the predefined matching criteria is particularly useful in gaming systems in which draw designations are required to be delivered in multiple groups, each group in response to some player action at the EPS or other player interface device.

Another example of predefined matching criteria used to identify the variable draw dividing point may be criteria for some intermediate or interim win available under the particular bingo game rules. For example, the bingo game may define a number of interim or intermediate prizes available in the bingo game awarded for matching the draw in various predefined patterns. The predefined matching criteria used to identify the variable draw dividing point may require that at least some number of winning patterns are produced by matching the first draw portion to the card representations. This sort of criteria may be used to maximize player satisfaction by showing the players winning results sooner in the bingo game. It should be noted that this sort of criteria regarding interim or intermediate winning patterns produced with the first draw portion may be combined with the criteria prohibiting a game ending pattern from being produced with the first draw portion.

The step of identifying the variable draw dividing point may be including identifying a single dividing point for the entire set of card representations in play in the bingo game or identifying a different dividing point for one or more card representations, or even each, card representation in play in the game. Thus, the matching criteria may require that the game ending pattern is not first matched for a given card representation yet some interim or intermediate winning pattern is produced for the given card with the first draw portion if the interim or intermediate winning pattern can be produced at all without revealing all of the designations in the draw to produce the first game ending pattern. This dividing point may be at designation number 15 for one card representation for example, and at designation number 20 for another card representation.

In one preferred embodiment of the present invention the predefined matching criteria requires that the given card representation in the set of card representations under consideration not be the first to produce the game ending pattern in the bingo game or a relatively high level prize or result in the bingo game, but produce some interim or intermediate result considering the first draw portion. The interim or intermediate result in this example may not guaranty a prize amount, but may simply enter the player in some other game such as a trivia game or other game that ultimately gives the player a chance at some prize or award. Using the variable draw division in this fashion facilitates the play of a separate game within the underlying bingo game and occupies and entertains the players that would not otherwise win in the bingo game while the higher level winners in bingo game are taking the necessary action or actions to claim their respective prize.

Regardless of what predefined matching criteria are used in identifying the variable draw dividing point, once the dividing point is identified, the first draw portion is communicated to the respective player or players for which the respective first draw portion applies as indicated at process block 403. Again, in a single bingo game, the variable draw dividing point and thus the first draw portion may be different for each player. In any event this communication of the respective first draw portion is preferably accomplished by communicating the first draw portion to a respective player interface device such as an EPS 103 associated with a player. The association may simply be that the player has initiated the game play request entering the card representation in the bingo game from the particular player interface. This communicating step is shown at process block 403 in FIG. 4 and is preferably performed with result communication program code executed at the game server (such as CGS 101 or LAS 102) that causes the first draw portion to be communicated to the respective player interface device through a suitable communication arrangement between the server and player interface device.

Process blocks 404 and 405 in FIG. 4 illustrate the process steps that may be performed in a bingo gaming system after the first draw portion is communicated to the players/player interface devices as indicated at process block 403. In one preferred bingo system, the other designations from the draw up to the designation required to first produce the apparent game ending winning pattern are communicated to the player or player interface in response to some player action as indicated at process block 404. This communication step may also be performed by the result communication program code executed by the game server. Final results in the bingo game are also preferably communicated to the players or player interface devices as indicated at process block 405. This communication of final results is illustrated as a separate step because certain preferred forms of bingo systems provide final results and award prizes associated with results only after some additional action from the respective game player. It will be appreciated, however, that the final results may be communicated with the remainder of the draw in a single step. In any event, the final results are communicated preferably under the control of the result communication program code executed by the game server.

It will be appreciated that the communications referred to in process blocks 403, 404, and 405 in FIG. 4 may be accomplished in many ways within the scope of the present invention. In one variation under the present invention, the entire draw is communicated or otherwise made available to a player interface device such as EPS 103 and stored in memory at the player interface device. Communicating the first draw portion in this case may be done by communicating to the player interface device a value representing the variable draw dividing point. For example, the value 15 may indicate that the dividing point is after the 15th designation in the draw and the first draw portion comprises the first 15 designations in the draw. The player interface device would respond to this dividing point information or value by displaying or otherwise communicating to the player the first draw portion, comprising the first 15 designations of the draw in our example. The remainder of the designations in the draw required to produce the apparent game ending winner, may similarly be communicated to the player interface device as a value representing a number of designations in the draw after the final designation considered part of the first draw portion.

Another important variation within the scope of the present invention that may be described with reference to FIG. 4 relates to the number of variable draw dividing points that may be identified according to the invention. In particular, although the previous discussion assumes that a single variable draw dividing point is identified either for each card representation or for one or more groups of card representations, or even a single card representation in the bingo game, it will be appreciated that the draw may be divided more than once for any given card representation. For example, the rules of a bingo game may require that the draw be delivered or communicated in three different sets for one or more game players. To accommodate this, the present invention may include identifying both a first variable draw dividing point and an additional variable draw dividing point for one or more card representations in play for a game.

FIGS. 5 and 6 show alternative processes that may be employed in identifying a variable draw dividing point (that is, selecting the number of designations to be included in the first draw portion) within the scope of the invention. These processes correspond to the identifying processes indicated at process block 402 in FIG. 4.

Referring to FIG. 5 a process for identifying a variable draw dividing point may include producing or obtaining a draw with a sufficient number of designations to ensure a game ending result for a given set of bingo card representations. Once the draw is obtained or produced as shown at process block 501, the process may include considering a next available designation in the draw and matching that designation to all of the card representations in play in the bingo game as shown at process block 502. This step at process block 502 includes determining whether the predefined matching criteria are met on that particular designation in the draw. In the event the predefined matching criteria are not met on this designation as indicated at decision block 503, the method includes branching back to process block 502 to consider a next designation in the draw. In the event the predefined matching criteria are met, the method proceeds to process block 504 and the number of designations considered to meet the criteria identify the variable draw dividing point and define the first draw portion for use in process block 403 in FIG. 4.

FIG. 6 shows an alternative process for identifying the variable draw dividing point as described with reference to FIG. 4 at process block 402. In the process of FIG. 6, a draw having sufficient designations to end the game is produced or obtained at process block 601. The method next includes matching the draw on a designation by designation basis to the various card representations in play for the given bingo game as shown at process block 602. This matching step produces sufficient information to determine whether the draw meets the predefined matching criteria for the given bingo cards and to identify the variable draw dividing point. If the draw meets the matching criteria as indicated at decision block 603, the system uses the draw and the identified variable draw dividing point as indicated at process block 604. In the event the draw does not meet the predefined matching criteria, the process discards or disregards the draw as indicated at process block 605 and returns to process block 601 to obtain a new draw to consider. This process may be repeated until a draw is identified that meets the predefined matching criteria.

The above described preferred embodiments are intended to illustrate the principles of the invention, but not to limit the scope of the invention. Various other embodiments and modifications to these preferred embodiments may be made by those skilled in the art without departing from the scope of the present invention. For example, although a particular hardware arrangement is shown for purposes of describing the invention, it will be appreciated that numerous hardware arrangements are possible for implementing the present invention. Also, although the operational software-controlled process steps are described as occurring at certain processing elements in the system, the processing steps may be distributed in any suitable fashion over various data processing elements.

1. A gaming method including the steps of:
(a) identifying a variable draw dividing point defining a first draw portion of a draw, the first draw portion matching a first card representation in play for a bingo game according to a predefined matching criterion; and
(b) communicating the first draw portion to a player associated with the first card representation.

2. The method of claim 1 wherein the step of identifying the variable draw dividing point includes the step of matching the designations of the draw to the first card representation.

3. The method of claim 1 wherein the predefined matching criterion requires that the first card representation does not match the first draw portion to produce a game ending result for the bingo game.

4. The method of claim 1 wherein the predefined matching criterion requires that the first card representation match the first draw portion to produce a first intermediate winning result.

5. The method of claim 1 further including the steps of:
(a) identifying an additional variable draw dividing point defining an additional draw portion of the draw, the additional draw portion matching the first card representation according to an additional predefined matching criterion; and
(b) communicating the additional draw portion to the player associated with first card representation.

6. The method of claim 5 wherein the step of identifying the additional variable draw dividing point includes matching the designations of the draw to the first card representation.

7. The method of claim 5 wherein the additional predefined matching criterion requires that the first card representation does not match the additional draw portion and first draw portion to produce a game ending result for the bingo game.

8. The method of claim 5 wherein the predefined matching criterion requires that the additional card representation match the additional draw portion and the first draw portion to produce an intermediate winning result.

9. A program product stored on a computer readable medium, the program product including:
(a) identifying program code for identifying a variable draw dividing point defining a first draw portion of a draw, the first draw portion matching a first card representation in play for a bingo game according to a predefined matching criterion; and
(b) result communication program code for communicating the first draw portion to a player associated with the first card representation.

10. The program product of claim 9 further including matching program code for matching the designations of the draw to the first card representation.

11. The program product of claim 9 wherein the predefined matching criterion requires that the first card representation does not match the first draw portion to produce a game ending result for the bingo game.

12. The program product of claim 9 wherein the predefined matching criterion requires that the first card representation match the first draw portion to produce a first intermediate winning result.

13. The program product of claim 9 wherein:
(a) the identifying program code is also for identifying an additional variable draw dividing point defining an additional draw portion, the additional draw portion matching the first card representation according to an additional predefined matching criterion; and
(b) the result communication program code is also for communicating the additional draw portion to the player associated with the first card representation.

14. The program product of claim 13 wherein the additional predefined matching criterion requires that the first card representation does not match the additional draw portion and first draw portion to produce the game ending result for the bingo game.

15. The program product of claim 13 wherein the additional predefined matching criterion requires that the first card representation match the additional draw portion and first draw portion to produce an intermediate winning result.

16. A gaming system including:
(a) a number of game play interface devices, each game play interface device enabling a player to place a bingo card in play in a bingo game; and
(b) a game server in communication with the game play interface devices, the game server for (i) identifying a variable draw dividing point defining a first draw portion of a draw, the first draw portion matching a first card representation in play for a bingo game according to a predefined matching criterion, and for (ii) causing the first draw portion to be communicated to a game play interface device associated with the first card representation.

17. The gaming system of claim 16 wherein the predefined matching criterion requires that the first card representation does not match the first draw portion to produce a game ending result for the bingo game.

18. The gaming system of claim 16 wherein the predefined matching criterion requires that the first card representation match the first draw portion to produce a first intermediate winning result.

19. The gaming system of claim 16 wherein the game server matches the designations of the draw to the first card representation to identify the variable draw dividing point.
